(19) United States
(12) Patent Application Publication
(10) Pub. No.: US 2008/0103887 A1
(43) Pub. Date: May 1, 2008

(54) SELECTING ADVERTISEMENTS BASED ON CONSUMER TRANSACTIONS

(75) Inventors: Jeffrey Oldham, San Jose, CA (US); Sheng Song, Sunnyvale, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/555,148

(22) Filed: Oct. 31, 2006

(51) Int. Cl. G06Q 30/00

(52) U.S. Cl. 705/14

(57) ABSTRACT

Systems, methods, and computer program products, are provided for selecting advertisements based on transactions. In one implementation, a computer-implemented method is provided that includes receiving information descriptive of a transaction, the information including an identification of an item from the transaction and identifying from a collection of advertisements one or more first advertisements based on an association identified between the first advertisements and the information. The method includes selecting one or more second advertisements from among the first advertisements and presenting the one or more second advertisement at the time of the transaction according to a ranking order. In another implementation, a method includes identifying one or more first advertisements based on an association between the first advertisements and information descriptive of a transaction, ranking one or more second advertisements from among the identified first advertisements, and presenting the second advertisements at least in part according to the ranking.

### BACKGROUND

The present disclosure relates to advertising.

Advertisers provide advertisements in different forms in order to attract consumers. An advertisement is a piece of information designed to be used in whole or part by a user, for example, a particular consumer. For example, an advertisement can be printed and delivered to consumers through the mail or within a newspaper. Advertisements can also be provided in electronic form, for example, as a banner advertisement on a web page. The presentation of an advertisement to a consumer, or simply the inclusion of an ad in a media can be called an impression.

The advertisement may include an incentive (e.g., a coupon or other discount) to encourage the consumer to purchase a particular product or service. If the consumer purchases the advertised product or service in response to the advertisement, it can be called a conversion. A conversion is said to occur when a user consummates a transaction related to a previously served advertisement. What constitutes a conversion may vary from case to case and can be determined in a variety of ways. For example, it may be the case that a conversion occurs when a user clicks on an advertisement, is referred to the advertiser's web page, and consummates a purchase there before leaving that web page. Alternatively, a conversion may be defined as a user being shown an advertisement, and making a purchase on the advertiser's web page within a predetermined time (e.g., within seven days). The greater the number of conversions relative to advertisement impressions, the more effective the advertisement.

### SUMMARY

In general, in one aspect, a computer-implemented method is provided. The method includes receiving information descriptive of a transaction, the information including an identification of an item from the transaction and identifying from a collection of advertisements one or more first advertisements based on an association identified between the first advertisements and the information. The method also includes selecting one or more second advertisements from among the first advertisements and presenting the one or more second advertisement at the time of the transaction according to a ranking order.

In general, in one aspect, a computer program product is provided. The computer program product includes instructions to perform operations including receiving information descriptive of a transaction, the information including an identification of a purchased product from the transaction and identifying from a collection of advertisements one or more first advertisements based on an association identified between the first advertisements and the information. The computer program product also includes instructions to perform operations including ranking the one or more first advertisements based on a payment model of each first advertisement and presenting an advertisement of the one or more first advertisements at the time of the transaction.

In general, in one aspect, a computer-implemented method is provided. The method includes identifying one or more first advertisements based on an association identified between the first advertisements and information descriptive of a transaction and ranking one or more second advertisements from among the identified first advertisements. The method also includes presenting the one or more second advertisements at the time of the transaction, the one or more second advertisements being presented at least in part according to the ranking.

In general, in one aspect, a system is provided. The system includes an advertising server configured to receive one or more advertisements from one or more advertisers. The system also includes a plurality of remote advertising appliances, each appliance configured to receive advertisements from the advertising server, the appliance matching received advertisements with items in a transaction and providing one or more advertisements to a user at the time of the transaction.

Particular embodiments of the subject matter described in this specification can be implemented to realize one or more of the following advantages. Advertisers are able to provide advertisements that are targeted to consumer transactions in order to increase the likelihood of a conversion associated with the advertisement impression. Consumers also benefit from being presented with advertisements in which they are more likely to have an interest.

The details of the various aspects of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example advertisement system.

FIG. 2 is a block diagram of another example advertisement system.

FIG. 3 shows an example process for providing transaction based advertisements.

FIG. 4 shows an example process for ranking an advertisement.

Like reference numbers and designations in the various drawings indicate like elements.

### DETAILED DESCRIPTION

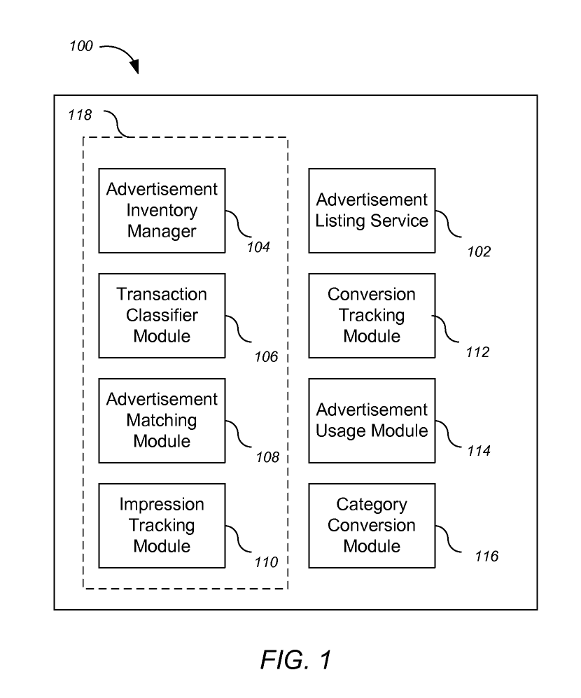

FIG. 1 is a block diagram of an example advertisement system 100. The advertisement system 100 provides one or more advertisements to an individual (e.g., a user of a product or service, both physical and online) at the time of a user transaction using information associated with the transaction itself. In some implementations, the provided advertisements are tracked for later conversion by the user. The advertisement system 100 includes an advertisement listing service 102, an advertisement inventory manager 104, a transaction classifier module 106, an advertisement matching module 108, an impression tracking module 110, a conversion tracking module 112, an advertisement usage module 114, and a category conversion module 116.

The advertisement listing service 102 allows an advertiser to set up an advertising campaign. In addition to one or more advertisements, the advertiser can provide, for example, target geographic information, product category information (e.g., of an advertised product or target categories for the advertisement), and budgeting information. The budgeting information can include a maximum limit to advertisements costs per unit time (e.g., daily limit, weekly limit) as well as limits based on particular geographic exposure (e.g., only 20 advertisement impressions per day in a given town).

In one implementation, the advertiser determines which pricing model is applied for the submitted advertisements. For example, in a charge per impression model, the advertiser pays for each advertisement presented to a user. In a charge per conversion model, the advertiser pays according to future action by the user after receiving the advertisement, for example, a purchase of a product identified by the advertisement. In a charge per conversion model, the advertiser can also provide a tracking code and expiration date (i.e., the date by which a received advertisement must be converted). Alternatively, the tracking code can be automatically generated by the advertising system 100. The tracking code can uniquely identify a particular advertisement or group of advertisements. Consequently, the tracking code can be used to derive information regarding the presentation of the advertisement after a user conversion of the advertisement.

The advertiser can also provide a bid amount, which is an amount the advertiser is willing to pay for a particular impression or conversion, respectively, depending on the payment model. The bid amount is used as one factor in determining which advertisement to present to a user at a given instance, as will be described in greater detail below. An auction process can also be used to determine a bid amount for a particular presentation of an advertisement.

The advertisers can also manage an existing advertising campaign using the advertisement listing service 102, for example, by changing or removing particular advertisements or by modifying a bid amount.

The advertisement inventory manager 104 manages advertisements eligible to be presented to a user. In one implementation, the advertisement inventory manager 104 organizes eligible advertisements according to one or more profiles. The profiles can be used to organize the advertisements, for example, based on geographic location and product or service categories associated with the advertisements. The advertisements of the inventory manager 104 can be updated periodically or continuously throughout the day, for example, according to advertisements received by the advertisement listing service 102.

The transaction classifier module 106 uses information descriptive of a particular transaction to determine one or more categories (e.g., product or service categories) associated with the item or items of the transaction. A category, for example, is a grouping of related items (whether products or services). Simple categories can include only a single item; however, other categories can include several different items. For example, a product category of fishing poles can include bamboo fishing poles and ice fishing poles, but not fishing bait. Items can belong to more than one category. In one implementation, the categories are arranged in a hierarchy (e.g., a tree or a directed acyclic graph). In the hierarchy, a category can include zero or more subcategories, where the contents of a category include each of the subcategories.

The advertisement matching module 108 matches advertisements from the advertisement inventory manager 104 using the one or more categories associated with a particular transaction and the one or more categories associated with the respective advertisements. The matched advertisements can then be ranked to determine which advertisement(s) to present to the user.

The impression tracking module 110 collects information associated with advertisement impressions (i.e., how many times particular advertisements are presented to users). The impression information can be used for accounting purposes, for example, in a charge per impression payment model.

The conversion tracking module 112 collects information associated with advertisement conversions. The originating advertisement for the conversion is tracked, for example, using a tracking code provided with the advertisement impression. The conversion information is used for accounting purposes, for example, in a charge per conversion payment model.

The advertisement usage module 114 receives impression data from the impression tracking module 110 and conversion information from the conversion tracking module 112. The advertisement usage module 114 uses the received information to associate a monetary value with the advertisement (i.e., an amount owed by an advertiser). In one implementation, the received information is used in determining payments to a transaction location where the advertisement impression occurred.

The category conversion module 116 associates conversions with categories associated with an advertisement (e.g., one or more categories identified by the advertiser as associated with the advertisement). A table or other convenient data structure can be generated to score conversion rates for particular categories (i.e., the effectiveness of the advertisement for particular product categories, an advertisement may be more effective in one category than another). In one implementation, a ranking algorithm used to select advertisements for presentation to a user can adjust selection according to the conversion rates for particular categories (ranking is described in greater detail below).

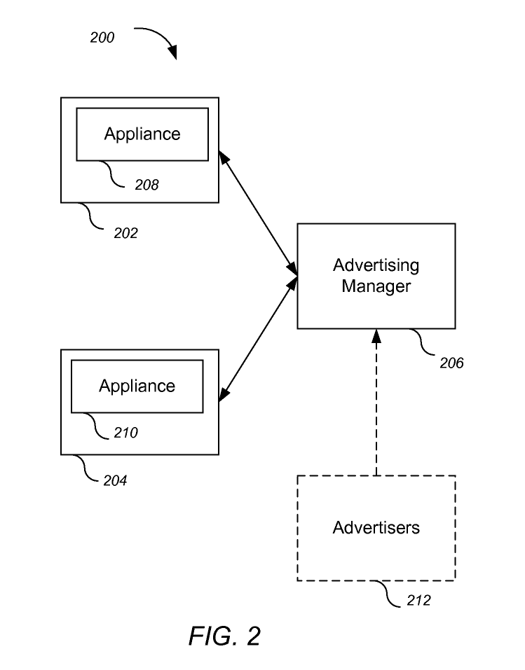

FIG. 2 is a block diagram of another example advertisement system 200. The advertisement system 200 is a distributed system in which some functions are performed locally at each transaction location 202, 204, while other functions are performed by a central advertising manager 206. A transaction location is a geographic location associated with the transaction. The transaction location can be, for example, a physical store location or the location of a user in an online transaction. An appliance 208, 210 is provided at each transaction location 202, 204, respectively, for performing functions of the advertising system. In one implementation, the appliance (e.g., appliance 208) includes the advertisement inventory manager 104, transaction classifier module 106, advertisement matching module 108, and impression tracking module 110, of FIG. 1.

The advertising manager 206 can include the advertisement listing service 102, conversion tracking module 112, advertisement usage module 114, and category conversion module 116. The appliances 208, 210 can communicate with the advertising manger 206, for example, using one or more communication systems (e.g., using a client-server or peer-to-peer protocol over a point-to-point or networked data communications channel such as a web services protocol over the Internet). For example, the advertising manager 206 can update the available advertisements in the advertisement inventory manager 104 of the appliances 208, 210. Additionally, the appliance 208, 210 can transmit information on advertisement impressions at the transaction location 202, 204 to the advertisement manager 206. The advertising manager 206 can also receive advertisements from advertisers 212. Thus, the appliances 208, 210 can include functions for matching and presenting advertisements to the user in, while the advertising manager 206 can include functions for receiving and distributing advertisements to the appliance 208, 210.

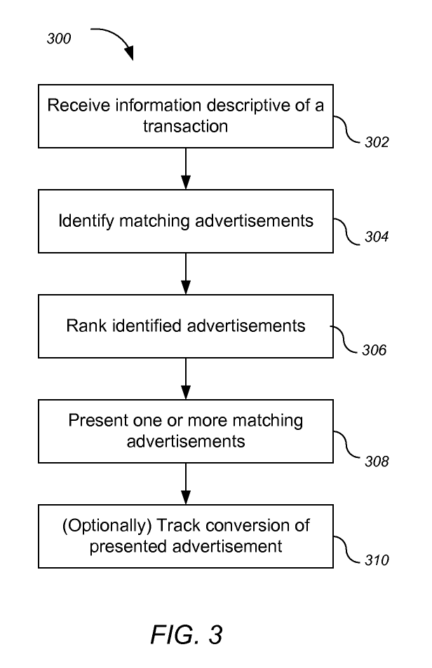

FIG. 3 shows an example process 300 for providing transaction-based advertisements. For convenience, the processes will be described with reference to a computer system that performs the process (e.g., the advertising system 100). The computer system receives information descriptive of a transaction (302). A transaction can be an interaction or agreement between two or more parties (e.g., a consumer (“user”) and a business entity). For example, a transaction can be the purchase of a physical item from a store (e.g., a real store or an online store) at a particular time and for a particular price. A transaction can also be the submission of a form on a webpage, selecting a checkbox on a webpage indicating agreement, or downloading software or other products (free or for payment). A transaction can also include providing a service. Services can include, for example, financial services such as credit card statements and news and information services. Additionally, services can include, for example, borrowing services such as checking out books from a library (real or virtual). Transactions can also include different types of logs logically associated with consumers that can be monetized such as user audio playlists.

The transaction occurs at a transaction location. The transaction location can be a physical location (e.g., a physical store) or a non-physical location (e.g., a website of an online store). For example, a particular user can access a particular online store and initiate a transaction by purchasing a product. Alternatively, the transaction location of a non-physical entity can be the same as the user's geographic location.

The information descriptive of the transaction can include other data. For example, for a product, the information can include product information such as a UPC (Universal Product Code) code, product ID, or product name. The information can also include the price of the product, the form of payment used, or the geographic location associated with the transaction (e.g., the transaction location or the location associated with the purchasing user). The information can specifically identify the category of the item or include the information from which the category or categories associated with the item can be identified.

The information descriptive of the transaction is received, for example, by an advertising system (e.g., advertising system 100 of FIG. 1). Alternatively, the information is received by an advertising appliance located locally with respect to the transaction (e.g., appliance 208 in advertising system 200 of FIG. 2).

The transmission of data can be encrypted or otherwise protected from interception during transmission to the advertising system. Additionally, privacy concerns can be addressed by limiting the types of data transmitted. In one implementation, minimal information is sent in order to maintain greater user privacy. However, the matching of potential advertisements can be less exact as a result.

In another implementation, a zero-knowledge system can be used to identify categories associated with the transaction item. In a zero-knowledge system, information about an item is transmitted in a manner that the item cannot be identified, yet the item can still be mapped to one or more categories without revealing any information about the item other than its associated categories. For example, an item's UPC value can be mapped to categories using a hash table. The UPC of an item in a transaction can be hashed before transmission. The hash value can then be used by the advertising system to determine the categories associated with that hash value without identifying the item.

The system uses the received information to identify matching advertisements (304). Matching advertisements can be identified, for example, according to the category or categories of the transaction item. For example, if the transaction is a user purchase of a particular product, the matching advertisements can be identified using that product category. Advertisements are also associated with particular categories (e.g., as chosen by the advertiser) which can be similar to, or correlated with, the categories of the item in the transaction. Therefore, matching advertisements can be identified, for example, by comparing the categories associated with the item with the categories associated with each advertisement.

A matching advertisement can include an incentive for a product in the same category. Alternatively, a matching advertisement includes an incentive for a product in a correlated category (e.g., transaction product A is correlated with product B). For example, a transaction item of ice cream might be matched to whipped cream because whipped cream is correlated with ice cream.

In one implementation, one or more other parameters are used to identify matching advertisements in addition to, or separate from, the categories of the transaction item and advertisements. These parameters can include the payment type for the transaction, the user's location, the transaction location, the time of the transaction, and the price paid for the item. Additionally, potential advertisements can be filtered from consideration according to the advertiser. For example, a competitor of an entity associated with the transaction location can be blocked from supplying advertisements to users in response to transactions at that transaction location.

The identified advertisements are ranked (306). The identified advertisements are ranked, in part, on the payment model for the individual advertisements. For example, in a charge per impression payment model, the advertiser pays based on each impression of a particular advertisement to a user (e.g., at the transaction location). Alternatively, in a charge per conversion payment model, the advertiser pays based on a later conversion as a result of the advertisement impression.

In one implementation, a ranking score for advertisements in a charge per impression payment model is determined by multiplying category relevance by the bid amount for the advertisement. The category relevance is the number of matched categories in the advertisement divided by the number of categories associated with the item of the transaction. The bid amount is the price offered by the advertiser for presenting the advertisement to the user. Thus, more relevant advertisements that have a lower bid amount can be ranked higher than advertisements with higher bid amounts but lower relevance. In one implementation, an auction is performed to determine bid amounts for a given transaction. For example, a Vickrey-Clarke-Groves auction can be used to instantaneously determine bid results for each identified advertisement. The auction can have other forms such as an interactive auction or a simultaneous ascending auction. In one implementation, the auction is constrained by a time limit for presenting an advertisement. The auction can also be constrained by a maximum bid amount.

A ranking score can also be calculated for a charge per conversion payment model. The conversion rate is the ratio of the number of advertisement conversions to the number of impressions of the advertisement. The conversion rate is therefore indicative of the effectiveness of the advertisement. Thus, in one implementation, a ranking score for an advertisement can be calculated as a product of the bid amount and conversion rate for the advertisement.

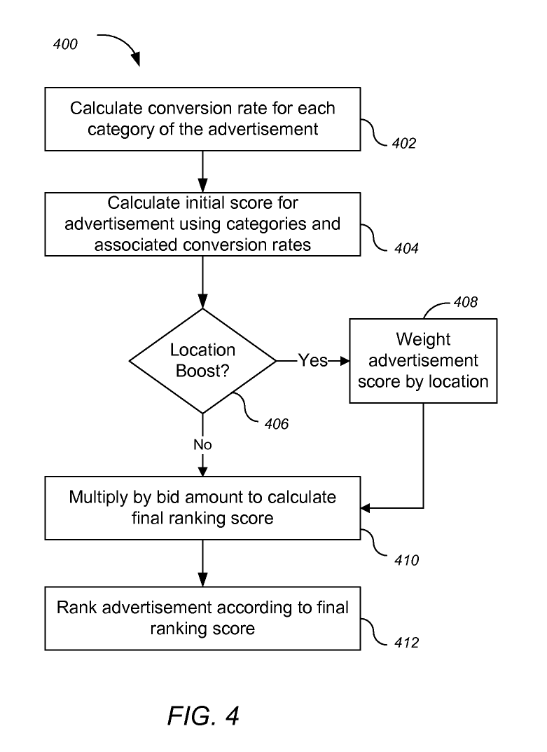

FIG. 4 shows an example process 400 for ranking an advertisement in a charge per conversion payment model where conversion time is also considered. For each matching category of an advertisement, the system calculates the category conversion rate. In one implementation, the calculation is performed using a conversion cumulative distribution function (“CCDF”), which is adapted to take the conversion time into account. The CCDF determines a cumulative distribution function over time aggregating conversion information for a particular advertisement at a particular transaction location.

The time is the interval between the advertisement impression at the transaction location and the advertisement conversion at any location. For a given time interval, (e.g., from t=0 to t=t1), the CCDF measures the cumulative probability of a conversion. In one implementation, the maximum time interval is between one and three months, however, the upper limit can vary, for example, depending on the particular type of transaction or conversion involved. The result for each time interval is a value from zero to one. Advertisement impressions without associated conversions are not included in the CCDF. The CCDF can be updated whenever a conversion occurs.

In one implementation, the CCDF's values of different advertisements can be compared in order to rank the advertisements. One example technique for comparing two advertisements (A and B) is to compare the CCDF values for the two advertisements over each time interval. The result is a fraction of the time intervals in which the CCDF value of one advertisement (e.g., A) is greater than the CCDF value of the other advertisement (e.g., B). A value of 1 indicates the CCDF value is greater for all time intervals, while a value of 0.5 indicates that the CCDF value is greater for half of the time intervals. If the value is greater than 0.5, the advertisement is ranked higher than the other (e.g., A ranked above B).

In one implementation, older conversions have less of a contribution to the CCDF than newer conversions. For example, an exponentially decreasing weight can be applied to conversions over time such that the oldest conversions have a minimal contribution to the CCDF. Thus, a particular exponential weight function can be chosen such that as the time interval increases the resulting weight applied to the conversions decrease along an exponential path.

Once the CCDF values for an advertisement at each time interval is calculated, an overall CCDF value for the advertisement can be determined. For example, the values for each time interval can be summed to provide an overall CCDF result. In one implementation, each time interval CCDF value is multiplied by a scalar amount in order to produce an overall result having a value between zero and one for the advertisement. Thus, a time-based conversion rate per category is determined for each matching advertisement.

An initial ranking score is calculated for each advertisement using the categories of the item or items and associated conversion rates for matching advertisement categories (404). For example, a separate conversion rate can be calculated for each matching advertisement category as described above. Each identified item category also has an initial weighting value. In one implementation, the initial weighting value of a particular item category is based on a conditional probability of a transaction happening in that category given that a transaction occurred in another category. The initial weightings can be adjusted over time according to identified conversions.

These category weight and conversion values can then be combined to provide the initial ranking score. The combined initial ranking score is the sum of the products of the category weight and the conversion rate for each matching advertisement category.

A determination is made as to whether a location boost is to be applied to the advertisements (406). If a location boost is to be applied, each advertisement can be weighted according to a location (408). A location boost can be applied to advertisements based on, for example, their respective location target relative to the transaction (or user) location. For example, a weighting multiplier can be applied to the initial ranking score based on whether the advertisement has a nation-wide target (e.g., 0.2), a regional target (e.g., 0.5), or a local target (e.g., 0.8). Thus, local advertisements can be boosted relative to large national advertising campaigns.

The system calculates a final ranking score by multiplying the score (with or without a location boost) by a bid amount for the advertisement (410). The bid amount can be determined in an auction process. For example, a Generalized Second Price auction can be used for charge per conversion advertisements to determine an instantaneous bid value for each particular advertisement. Generalized Second Price auctions are described, for example, in Edelman et al, “Internet Advertising and the Generalized Second Price Auction: Selling Billions of Dollars Worth of Keywords,” Aug. 23, 2005 (available at http://repositories.cdlib.org/berkeley_econ221/fall2005/1/), which is hereby incorporated by reference. The advertisements are then ranked according to the final ranking score (412).

A specific example of ranking in a charge per impression payment model is as follows:

Assume a transaction includes two items 1 and 2. Based on the two items, four product categories are identified, each product category having initial weights (category, weight) as:

(Category 1, 0.4); (Category 2, 0.3); (Category 3, 0.2); and (Category 4, 0.1).

Based on these categories, the advertisement matching results in three matching advertisements:

Advertisement A (matching Category 1, Category 3, and Category 4),

Advertisement B (matching Category 1, Category 2, Category 3, and Category 4),

Advertisement C (matching Category 1, Category 2, and Category 4).

The CCDF score for each product category is calculated for each advertisement:

Advertisement A: (Category 1, 0.4); (Category 3, 0.2); (Category 4, 0.3),

Advertisement B: (Category 1, 0.2); (Category 2, 0.3); (Category 3, 0.3); (Category 4, 0.2),

Advertisement C: (Category 1, 0.5); (Category 2, 0.2); (Category 4, 0.3).

Calculating the initial ranking score for each advertisement according to category and CCDF results in:

Advertisement A: (0.4*0.4+0.2*0.2+0.3*0.1)=0.23;

Advertisement B: (0.2*0.4+0.3*0.3+0.3*0.2+0.2*0.1)=0.25;

Advertisement C: (0.5*0.4+0.2*0.3+0.3*0.1)=0.29.

The location boost is applied in this example. Advertisements A and B are local advertisements (0.8 multiplier) while Advertisement C is a regional advertisement (0.5 multiplier), therefore:

Advertisement A: (0.23*0.8)=0.184;

Advertisement B: (0.25*0.8)=0.2;

Advertisement C: (0.29*0.5)=0.145.

Multiplying by the bid amount determines the final ranking score for the advertisements, which in order are:

Advertisement B: (0.2*$8)=$1.60 (highest rank);

Advertisement A: (0.184*$5.00)=$0.92;

Advertisement C: (0.145*$6.00)=$0.87 (lowest rank).

Other parameters can be included in the ranking process under either payment model in order to tune the ranking results. One or more of the parameters can be used to apply a weighting function to the calculated ranking. For example, an advertisement can target a particular time window or weather conditions (e.g., want sun block advertisement presented on sunny days). A multiplier can therefore be applied to advertisements based on time of day or weather conditions. Additionally, the price paid by the user in the transaction can be a parameter used. For example, a weighting can be applied which favors advertisements within a particular price range relative to the price paid by the user.

The system presents one or more matching advertisements to the user contemporaneously in time with the transaction (308). The presentation can be made at least in part on the ranking score for the matching advertisements. In one implementation, the advertisement is presented to the user with the transaction receipt (electronic or virtual). For example, a paper receipt can have one or more advertisements printed at the top of the receipt followed by the record of purchased items. Alternatively, the advertisements can be placed at the bottom of the receipt, or interspaced between items listed on the receipt (e.g., above or below the item associated with the advertisement). In another implementation, the advertisements are transmitted to the user electronically, for example, to an email account or mobile phone. Alternatively, the advertisements can be transmitted to a user account, for example, associated with a user's frequent shopping card. The advertisements can be transmitted to the user's account when the user swipes their card during the transaction.

In one implementation, ranked advertisements are filtered according to a threshold value, only presenting advertisements exceeding the threshold. For example, if there are three advertisements A, B, and C ranked at $1.60, $0.92, and $0.87, respectively (e.g., advertisement score multiplied by bid amount), a threshold can require a minimum ranking value of $1.00. Consequently, only advertisement A will be presented to the user as the only one exceeding the threshold amount. Alternatively or in addition, a numerical limit of advertisements per transaction can be applied. For example, only two advertisements presented per transaction such that for the example advertisements above, advertisements A and B will be presented to the user.

The system can optionally track conversions of presented advertisements (310). For example, in a charge per conversion payment model, tracking the conversion is used to determine when payment is required. Additionally, tracking the conversion time can be used to update the CCDF associated with the advertisement and transaction location. In one implementation, a presented advertisement includes a tracking code. The tracking code is used to connect the transaction location with the conversion location as well as the time interval between the two. The tracking code can be denoted using a set of alphanumeric characters, an image, a bar code, or other decipherable representation readable by machine or human at the conversion location.

In one implementation, the tracking code identifies the particular advertisement and the transaction time. In another implementation, the tracking code also includes additional information identifying the unique impression number of the particular advertisements. The information can be encrypted so that the data can not be identified except by the advertising system. One or more check bits or other checking scheme can be used to ensure the tracking numbers cannot be easily forged by third parties. Alternatively the tracking code can serve as an index to information stored by the advertising system. Thus, the adverting system can use the tracking code received from the conversion location to identify information associated with the advertisement.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer program products, i.e., one or more modules of computer program instructions encoded on a computer-readable medium for execution by, or to control the operation of, data processing apparatus. The instructions can be organized into modules in different numbers and combinations from the exemplary modules described. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer-implemented method comprising:
receiving information descriptive of a transaction, the information including an identification of an item from the transaction;
identifying from a collection of advertisements one or more first advertisements based on an association identified between the first advertisements and the information;
selecting one or more second advertisements from among the first advertisements; and
presenting the one or more second advertisements at the time of the transaction according to a ranking order.

2. The method of claim 1, further comprising determining a respective rank score for each of the one or more first advertisements, where selecting one or more second advertisements is based on the determined rank scores.

3. The method of claim 2, where determining a rank score for each first advertisement is based on a payment model of each respective first advertisement.

4. The method of claim 2, where determining a rank score for each first advertisement includes determining a rank score for a subset of advertisements in the collection of advertisements.

5. The method of claim 2, where determining a respective rank score for the one or more first advertisements includes determining a relevance of a respective category associated with each advertisement with one or more categories of the purchased item.

6. The method of claim 2, where determining a respective rank score for an advertisement comprises determining the respective rank score based on a charge per impression payment model using a determined relevance of the advertisement and a bid amount for the advertisement.

7. The method of claim 2, where determining a respective rank score for an advertisement comprises determining the respective rank score based on a charge per conversion payment model using a bid amount and a conversion rate for the advertisement.

8. The method of claim 7, where the rank score is further based on a conversion time.

9. The method of claim 2, where determining a respective rank score for an advertisement comprises determining the respective rank score according to a price of the purchased product.

10. The method of claim 2, where determining a respective rank score for an advertisement comprises determining the respective rank score according to a time of the transaction.

11. The method of claim 1, further comprising dynamically updating the collection of advertisements.

12. The method of claim 1, where presenting the advertisement includes presenting an advertisement that includes a unique identifier for tracking a conversion associated with the advertisement.

13. The method of claim 1, where the information includes a location associated with the transaction and applying a weight to the rank scores based on the location.

14. The method of claim 1, where identifying one or more first advertisements includes determining a category of the purchased item and identifying one or more first advertisements associated with the category.

15. The method of claim 1, where determining a rank score for each respective first advertisement includes excluding one or more competitor advertisements.

16. The method of claim 1, where the item is a product.

17. The method of claim 1, where the item is a service.

18. A computer program product, encoded on a computer-readable medium, operable to cause data processing apparatus to perform operations comprising:
receiving information descriptive of a transaction, the information including an identification of a purchased product from the transaction;
identifying from a collection of advertisements one or more first advertisements based on an association identified between the first advertisements and the information;
ranking the one or more first advertisements based on a payment model of each first advertisement; and
presenting an advertisement of the one or more first advertisements at the time of the transaction.

19. The computer program product of claim 18, further comprising determining a respective rank score for each of the one or more first advertisements, where selecting one or more second advertisements is based on the determined rank scores.

20. The computer program product of claim 19, where determining a rank score for each first advertisement is based on a payment model of each respective first advertisement.

21. The computer program product of claim 19, where determining a rank score for each first advertisement includes determining a rank score for a subset of advertisements in the collection of advertisements.

22. The computer program product of claim 19, where determining a respective rank score for the one or more first advertisements includes determining a relevance of a respective category associated with each advertisement with one or more categories of the purchased item.

23. The computer program product of claim 19, where determining a respective rank score for an advertisement comprises determining the respective rank score based on a charge per impression payment model using a determined relevance of the advertisement and a bid amount for the advertisement.

24. The computer program product of claim 19, where determining a respective rank score for an advertisement comprises determining the respective rank score based on a charge per conversion payment model using a bid amount and a conversion rate for the advertisement.

25. The computer program product of claim 19, where determining a respective rank score for an advertisement comprises determining the respective rank score according to a price of the purchased product.

26. The computer program product of claim 19, where determining a respective rank score for an advertisement comprises determining the respective rank score according to a time of the transaction.

27. The computer program product of claim 18, where the information includes a location associated with the transaction and applying a weight to the rank scores based on the location.

28. The computer program product of claim 18, where identifying one or more first advertisements includes determining a category of the purchased item and identifying one or more first advertisements associated with the category.

29. The computer program product of claim 18, where determining a rank score for each respective first advertisement includes excluding one or more competitor advertisements.

30. A computer-implemented method comprising:
identifying one or more first advertisements based on an association between the first advertisements and information descriptive of a transaction;
ranking one or more second advertisements from among the identified first advertisements; and
presenting the one or more second advertisements at the time of the transaction, the one or more second advertisements being presented at least in part according to the ranking.

31. A system comprising:
means for receiving information descriptive of a transaction, the information including an identification of a purchased product from the transaction;
means for identifying from a collection of advertisements one or more first advertisements based on an association identified between the first advertisements and the information;
means for ranking the one or more first advertisements based on a payment model of each first advertisement; and
means for presenting an advertisement of the one or more first advertisements at the time of the transaction.

32. A system comprising:
an advertising server configured to receive one or more advertisements from one or more advertisers; and
a plurality of remote advertising appliances, each appliance configured to receive advertisements from the advertising server, the appliance matching received advertisements with items in a transaction and providing one or more advertisements to a user at the time of the transaction.
